(19) United States
(12) Patent Application Publication
(10) Pub. No.: US 2017/0344533 A1
(43) Pub. Date: Nov. 30, 2017

(54) PATENT CLAIMS DISASSEMBLING AND ANALYZING METHOD

(71) Applicant: INTEGRAL SEARCH INTERNATIONAL LTD., Taipei City (TW)

(72) Inventor: Hong-Shin TSAI, Taipei City (TW)

(73) Assignee: INTEGRAL SEARCH INTERNATIONAL LTD., Taipei City (TW)

(21) Appl. No.: 15/169,581

(22) Filed: May 31, 2016

(51) Int. Cl. G06F 17/27; G06F 17/30

(52) U.S. Cl. CPC G06F 17/2775; G06F 17/30666; G06F 17/2705; G06F 17/277

(57) ABSTRACT

A patent claims disassembling and analyzing device which automatically retrieves a patent claims and performs the following modules: a claim dependency determining module, a patent-claims-separating module, a preamble retrieving module, an independent-claim-element-analyzing module, and a dependent-claim-element-analyzing module, thereby disassembling and analyzing a patent claims of a patent.

### FIELD OF THE INVENTION

The present invention relates to a patent claims disassembling and analyzing method.

### BACKGROUND OF THE INVENTION

Claims of a patent specification are provided to define technical features of the patent application, where a patent specification generally includes a plurality of claims. Each claim is formed by defining a preamble and element or elements as well. A claim is generally defined to include a main element and a minor element, wherein a mutual relationship between the main element and the minor element is also defined. The mutual relationship can be a connecting relationship and/or a superior-subordinate relationship and/or a positional relationship. The technical features of a patent application are thus defined in connection to the preamble, the element, and the mutual relationship between the main element and the minor element.

The inventor of the present invention finds that there have not been any patent searching product in the market with high disassembling processing efficiency to allow a user, by providing the user with an interface for the user to input a keyword or keywords, to perform searching regarding the preamble, the element and the mutual relationship between the main element and minor element which are stored in a patent database. In other words, the conventional patent searching product in the market cannot provide a user with an effective method to obtain a plurality of patent applications which correspond to the keyword in connection to the preamble and/or the element and/or the mutual relationship between the elements.

With the complexity of a patent claims disassembling and analyzing method, an efficient method should be regarded as with less process but still performing excellently, since the amount of data existing in a patent database is considerably enormous. Taking the United Stated Patent and Trademark Office (USPTO) as an example, the number of granted US patent applications is as many as 5.2 million, and the number of published applications is 3.96 million, in which each patent application includes approximately dozens or even hundreds of claims, and thus the number of claims in whole patent database is as large as more than a hundred million. It is thus a challenge to find a method to analyze the patent claims with fewer procedures and with better efficiency in order to prevent any unnecessary procedures that delay the processing speed. In terms of efficiency, we can understand a patent claims disassembling and analyzing method with one extra procedure will cause several million more procedures in the disassembling and analyzing process. Moreover, since, in an automatic program system, it may still requires a check of accuracy by human being after every single procedure, it will further cause a waste of manpower since every extra searching process will cause other extra unnecessary checking procedures.

Regarding conventional disassembling and analyzing methods, taking two Taiwanese patents with patent no. 347561 and patent no. 400621 as examples, they are achieved by forming a table of conjunction terms in which it includes terms such as “comprise”, “include”, “have/has”, “are/is composed of” and “includes the steps”. However, the table of conjunction terms should be inevitably prepared by neglecting some conjunction terms, since it is difficult to collect all possible conjunction terms because the conjunction terms in the claims are usually expressed and chosen in various forms by various different patent attorneys. Accordingly, the table of conjunction terms is formed incompletely. Furthermore the lookup times of table with such huge amount of conjunction terms are expected to be time-consuming. Therefore, the above two conventional disassembling and analyzing methods are not ideal. Besides, the two conventional disassembling and analyzing methods further provide a process to separate a “body portion” from the preamble so as to further disassemble the elements in the body portion, wherein the “body portion” refers to a portion after a conjunction term. However, the process which separates the body portion from the preamble does not contribute much goodness to the claim analysis since in fact it will require extra computer space of database tables to store the separated body portions, thus leading to the increase of complexity of the analysis process and a waste of data storage space and data processing time as well. Moreover, the two conventional disassembling and analyzing methods are not ideal since they do not provide a solution for disassembling a portion of preamble, whereas the two conventional disassembling and analyzing methods merely provide the preamble without any further disassembling by which the element existing in the preamble cannot be specifically retrieved for searching. Furthermore, the most important reason compared to others is: in conventional patent-claims-analyzing methods, there have not been any patent claims analyzing methods that utilize part of speech to disassemble and analyze patent claims to obtain main elements and minor elements.

The object of the present invention provides a patent claims analyzing method which is with merits that utilizes part of speech to disassemble and analyze patent claims to obtain main elements and minor elements, utilizing storage space in a more efficient way having computation time more speedy over the prior arts whose disadvantage is that it wastes the resources such as storage space, computation time, and manpower.

### SUMMARY OF THE INVENTION

Accordingly, the object of the present invention is to provide a patent claims disassembling and analyzing method which utilizes part of speech to disassemble and analyze patent claims to obtain main elements and minor elements, and utilizes storage space more efficiently and saves computation time as well so as to improve the redundant and inefficient analysis method over the prior arts which causes a waste of resources such as storage space, computation time, and manpower.

To solve the problems in the prior art, the present invention provides a patent claims disassembling and analyzing method which automatically retrieves a patent claims from a patent specification, the method comprising: an claim dependency determining step which determines whether one claim of the patent claims is an independent claim or a dependent claim; a patent-claims-separating step which separates the patent claims into individual claims according to the numbering together with punctuation marks of the patent claims; a preamble retrieving step which retrieves a preamble from each individual claim separated from the patent claims by the patent-claims-separating step; an independent-claim-element-analyzing step which disassembles the independent claim determined by the claim dependency determining step by disassembling a definition in a portion after a colon in the independent claim, thereby obtaining a main element of the independent claim and a minor element of the independent claim; and a dependent-claim-element-analyzing step which disassembles the dependent claim determined by the claim dependency determining step by disassembling a definition portion after a comma in the dependent claim, thereby obtaining a main element of the dependent claim and a minor element of the dependent claim.

In one embodiment of the present invention, the preamble retrieving step further includes retrieving a main preamble and a minor preamble.

In one embodiment of the present invention, the independent-claim-element-analyzing step and/or the dependent-claim-element-analyzing step further determine the mutual relationship between the main element of an independent claim and the minor element of a dependent claim, and determine the mutual relationship between the main element of a dependent claim and the minor element of a dependent claim.

In one embodiment of the present invention, the main preamble and the minor preamble are retrieved by means of the detection of colons and the detection of commas.

In one embodiment of the present invention, the patent claims disassembling and analyzing method further comprises an independent-claim-storing step which stores, in an independent-claim-database table, a preamble of an independent claim and all of the main elements and the minor elements belonging to the independent claim.

In one embodiment of the present invention, the patent claims disassembling and analyzing method further comprises a dependent-claim-storing step which stores, in a dependent-claim-database table, a preamble of a dependent claim, all of the main elements and minor elements of the dependent claim, and all of the main elements and minor elements of the independent claim on which the dependent claim depends.

In one embodiment of the present invention, the patent claims disassembling and analyzing method further comprises a searching step which searches the independent-claim-database table and the dependent-claim-database table so as to obtain data relating to a patent specification to which the independent-claim-database table and the dependent-claim-database table belong.

In one embodiment of the present invention, the mutual relationship includes a connecting relationship and/or a superior-subordinate relationship and/or a positional relationship.

In one embodiment of the present invention, the independent-claim-element-analyzing step and/or the dependent-claim-element-analyzing step perform operation which directly disassembles the definition part located behind the colon to obtain all the main elements and the minor elements corresponding to each main element rather than performing operation which further divides the definition portion located behind the colon.

The patent claims disassembling and analyzing method of the present invention utilizes part of speech to disassemble and analyze patent claims to obtain main elements and minor elements, and utilizes storage space more efficiently and saves computation time as well so as to improve the redundant and inefficient analysis method over the prior arts which causes a waste of resources such as storage space, computation time, and manpower.

### BRIEF DESCRIPTION OF THE DRAWINGS

FIG. 1 is a flow chart of the patent claims disassembling and analyzing method according to one embodiment of the present invention.

FIG. 2 is a schematic diagram illustrating an independent claim as an example according to one embodiment of the present invention.

FIG. 3 is a logic table created according to a part-of-speech table.

FIG. 4 is another flow chart of the patent claims disassembling and analyzing method according to one embodiment of the present invention.

FIG. 5 and FIG. 6 are other flow charts of the patent claims disassembling and analyzing method according to embodiments of the present invention.

### DETAILED DESCRIPTION OF THE PREFERRED EMBODIMENTS

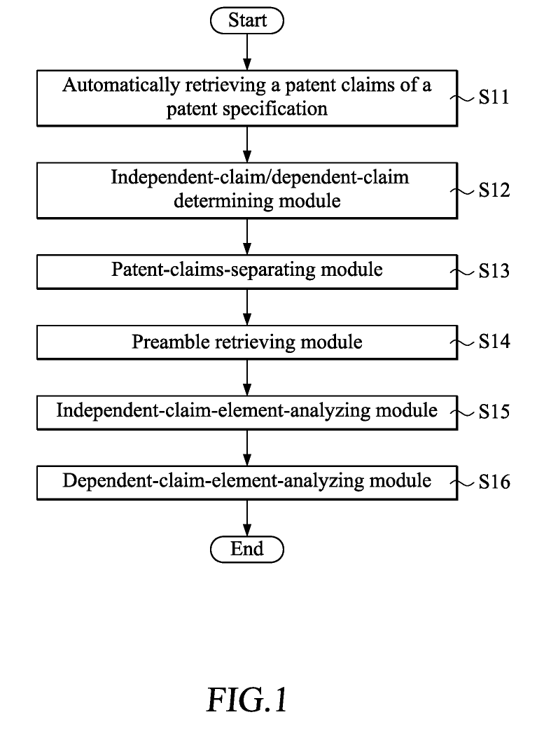

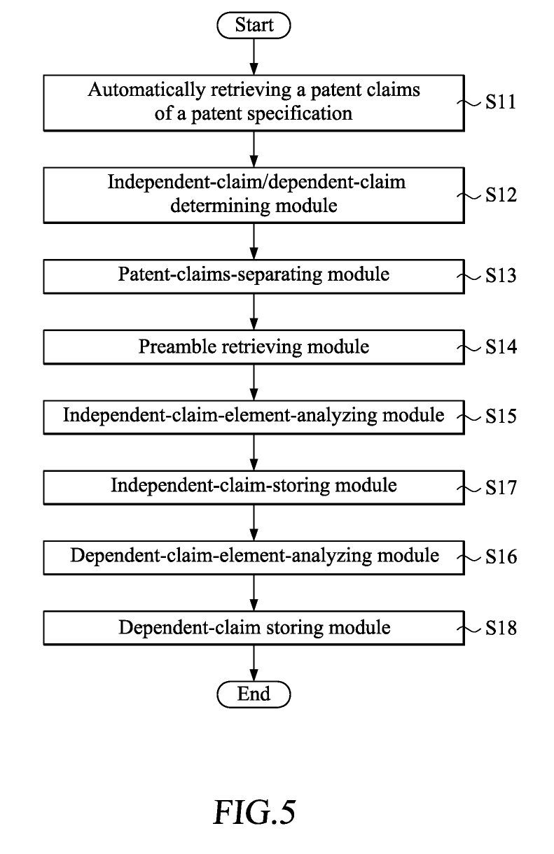

The preferred embodiments of the present invention are described below with reference to FIG. 1 to FIG. 6. The description is not to be taken in a limiting sense, but is made merely for the purpose of illustrating the general principles of the invention.

FIG. 1 is a flow chart of a patent claims disassembling and analyzing method of the present invention. The patent claims disassembling and analyzing method of the present invention automatically retrieves a patent claims from a patent specification (S11) and performs the following steps comprising: an independent-claim/dependent-claim determining step (S12) which determines whether one claim of the patent claims is an independent claim or a dependent claim; a patent-claims-separating step (S13) which separates the patent claims into individual claims according to the numbering together with punctuation marks of the patent claims; a preamble retrieving step (S14) which retrieves a preamble from each individual claim separated from the patent claims by the patent-claims-separating step; an independent-claim-element-analyzing step (S15) which disassembles the independent claim determined by the claim dependency determining step by disassembling a definition in a portion after a colon in the independent claim, thereby obtaining a main element of the independent claim and a minor element of the independent claim; and a dependent-claim-element-analyzing step (S16) which disassembles the dependent claim determined by the claim dependency determining step by disassembling a definition portion after a comma in the dependent claim, thereby obtaining a main element of the dependent claim and a minor element of the dependent claim.

In the step of automatically retrieving a patent claims from a patent specification (S11), identified patent claims or patent claims already stored in patent-claims units. The patent claims is composed of a plurality of claims, which is the target of disassembling and analyzing of the present invention, and which include independent claims and dependent claims. In the present invention, the importance of each claim is determined via determining whether the claim is an independent claim or a dependent claim. The elements of an independent claim imply with higher importance than those of a dependent claim.

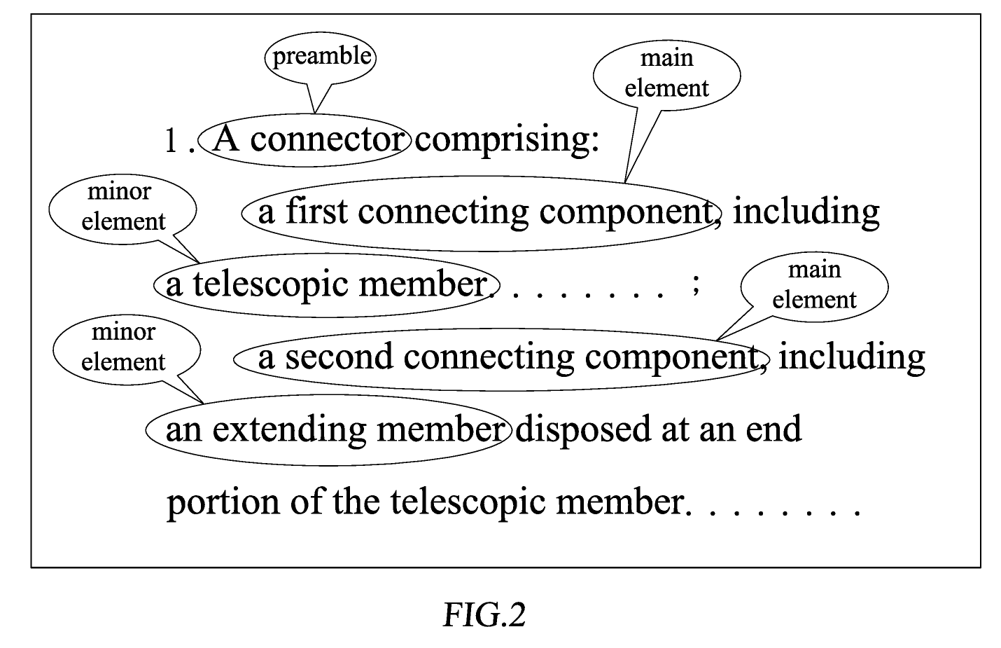

FIG. 2 illustrates an independent claim as an example. FIG. 2 shows a preamble of the independent claim, which is followed by a colon preceding one or a plurality of main elements to be disassembled and analyzed. As shown in FIG. 2, the main element called “first connecting element” includes a minor element called “telescopic member”, and the main element called “second connecting element” includes a minor element called “extending member”. The minor element “telescopic member” is in a corresponding relationship with the main element “first connecting element” by means of a term of conjunction, i.e. “include”.

The object of the present invention is to efficiently disassemble each claim into “preamble”, “main element”, “minor element”, and “the corresponding relationship between a main element and a minor element” so as to facilitate the process of patent claims searching performed by the users, thereby obtaining precise search results and accurate analysis results as well.

The independent-claim/dependent-claim determining step (S12) as shown in FIG. 1 determines whether one claim of the patent claims is an independent claim or a dependent claim according to an independent-claim/dependent-claim determining terms. The independent-claim/dependent-claim determining terms comprises: (1) a digit-number, (2) a symbol of “.”, (3) a term of “of claim”, (4) a term of “to claim” and (5) a term of “in claim”. The logic of determination is as follows. At first it determines whether the claim starts with a digit-number followed by the symbol of “.” and whether it does not appear the terms including “of claim” or “to claim” or “in claim” after the symbol of “.” before the end of the claim. If it is positive, then the claim is an independent claim. Otherwise, if it is negative, then the claim is a dependent claim. This kind of determination method only requires a very few data for performing comparison to thus be effective in determining process.

The patent-claims-separating step (S13) as shown in FIG. 1 separates the patent claims into individual claims according to a symbol combination formed by a sequence constituted by a digit-number, a punctuation mark and a blank. For example, the symbol combination can be “1.”, “35.” or “125.”, where the digit-number can be a one-digit-number, a two-digit-number or a digit-number whose digit length is not limited. In conventional patent-claim disassembling and analyzing method, the disassembling process is performed using periods, which requires time-consuming text parsing and retrieval operation on the claim, whereas the mechanism mentioned above in the present invention is relatively much simpler which can be achieved by only using SQL language to separate the claim with respect to the symbol combination so as to reduce time it takes to separate the claims.

The order of the independent-claim/dependent-claim determining step (S12) and the patent-claims-separating step (S13) and be reversed. The claim dependency determining step (S12) is not limited to precede the patent-claims-separating step (S13).

After each individual claim is separated in the patent-claims-separating step, the preamble retrieving step (S14) as shown in FIG. 1 uses a symbol of colon, i.e., “:”, to retrieve a preamble from the patent claims. The present invention is advantageous to use a colon to retrieve a preamble instead of using a data table as applied by the prior conventional patent-claim disassembling and analyzing methods. The prior arts usually use a data table to retrieve a preamble, where the data table is a table in connection to conjunction terms, in which the conjunction terms are terms of “comprise”, “include”, “have/has”, “is composed of”, etc. Since the conjunction terms included in the database table in prior arts is comprehensive; therefore, it is difficult for the prior art to build a complete database table including all conjunction terms to thus the neglected incompletion always happens when building the database table. It is absolutely not practical to create a database table for collecting such wide range information, and the efficiency for its operation in a computer system is criticized. The incomplete database table also causes more manual check for the result, which makes the use of database table in the prior art inefficient. In the present invention, the retrieval of preamble is performed only using a symbol of colon, i.e., “:”, which is more efficient than the method in prior art.

The independent-claim-element-analyzing step (S15) as shown in FIG. 1 is operated to obtain a main element of the independent claim and a minor element of the independent claim, in which the independent claim is determined by the independent-claim/dependent-claim determining step (S12). As shown in FIG. 2, in this step, the noun immediately following a term of “: a” or a term of “: an” is determined as a first word of a main element. As to the ending word of the main element, the present invention is advantageous in that it is determined by a database table of part of speech, i.e. a logic table. The following explanation is made by taking a process for disassembling and analyzing an English patent claims as an example. A process for disassembling and analyzing patent claims in other language is with a similar theory, whose explanation is omitted here. The database table of part of speech is formed by a plurality of groups of part of speech, each of which is in connection to one part of speech. The explanation is as follows.

The parts of speech defined in the database table of part of speech can be classified to several groups comprises: a group of preceding nouns, a group of relative pronouns, a group of verbs of belongingness, an group of participle, a group of prepositions, a group of direct-ending words, and a group of exceptions. The special feature of the present invention is in that each group of part of speech does not need to record all of the words belonging to this group of part of speech, but only record “what kinds of words should be taken as being belonged to this group of part of speech” and its reception words. Taking the group of participles as an example, it records the following kinds of words belonging to the group of participles: (1) a word with the ending letters of “ing”; (2) a word with the ending letter of “ed”; (3) exception rules. The exception rules record: (1) the words with form of participle but not belonging to the participle such as “need”, “spring” where their ending letters are “ed” or “ing”.

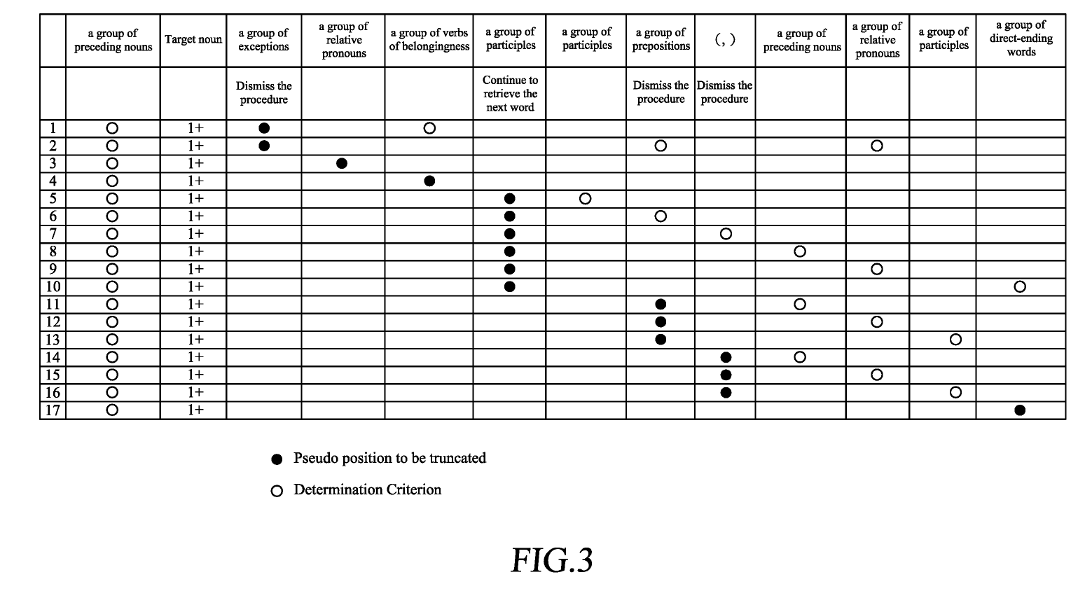

As shown in FIG. 3, a logic table is illustrated, which is created in connection to the above-mentioned various groups of part of speech. The following explanation is made by taking a text “a circuit board provided with edges extending in a longitudinal direction of said circuit board;” as an example to further explain how the elements in the patent claims is retrieved. Please also refer to FIG. 3.

When [a] is obtained such as expressed in the text “[a] circuit board provided with edges extending in a longitudinal direction of said circuit board;”, the logic table determines to continue to read the next words as illustrating “1+” in the third column since [a] belongs to “a group of preceding noun”, which is illustrated in the third column. The method of the present invention then continues to read the next word, which is [circuit] such as expressed in the text “a [circuit] board provided with edges extending in a longitudinal direction of said circuit board;”. Since [circuit] does not belong to any group of part of speech, the method of the present invention then continues to retrieve the next word “board”, whose process can be expressed as “a circuit [board] provided with edges extending in a longitudinal direction of said circuit board;”. Since [circuit] does not belong to any group of part of speech, the method of the present invention then continues to read the next word [provided], which is “a circuit board [provided] with edges extending in a longitudinal direction of said circuit board;”. Since [provided] belongs to the group of participles because of ending letters of “ed” thereof and being words not within the exception rule, that is to say, [provided] is a participle, the method then proceeds to be on any of procedures illustrated from the row numbered “5” to the row numbered “10”. These six rows are illustrated common in all in a situation of reading a participle and being marked with “” where it will take the position of the participle as a pseudo position to be truncated, and then continue to read the following words so as to decide whether the pseudo position to be truncated will become an ending word of the element. Next, the word [with] is read such as expressed by “a circuit board provided [with] edges extending in a longitudinal direction of said circuit board;” is retrieved. Since [with] belongs to the group of preposition, it matches the definition in the row with number “6” in the logic table marked with “◯” such that the row numbered “6” shows that the position of the pseudo position to be truncated, i.e., a participle of “provided”, is determined to be an ending word, where the preposition “with” is read to determine that a word with mark “”, which is “provided”, should be taken as a truncate word in such a manner that the words preceding the participle of “provided” should be retrieved. And since the term of “circuit board” is a term initially retrieved at the beginning of a definition of element, the term “circuit board” is taken as a main element. After the main element is found, the preceding noun and the pseudo position to be truncated are to be erased, i.e. the text resumes a status without any pseudo position to be truncated, and then the method of the present invention proceeds to continue read the next word [edges] such as expressed by “a circuit board provided with [edges] extending in a longitudinal direction of said circuit board;”. Since [edges] is a word ending with “s”, the logic table determines [edges] as a preceding noun since [edges] is a word with ending letter of “s” and the word with ending letter of “s” is determined as a preceding noun when a preceding noun has just been erased and has not yet determined. The method of the present invention then continues to read the next word “extending” such as expressed by “a circuit board provided with edges [extending] in a longitudinal direction of said circuit board;”. Since [extending] belongs to the group of participles, the method then proceeds to perform the processing procedures illustrated in the row numbered “5” to the row numbered “10”, and takes the position of “extending” as a pseudo position to be truncated, and the next determination depends on the next word being read. Next, the word [in] as expressed by “a circuit board provided with edges extending [in] a longitudinal direction of said circuit board;” is read. Since [in] belongs to the group of prepositions, which conforms to the criterion of the sixth row, the position of “extending” is then taken as a position of truncate word. Therefore, the word “edges” is retrieved. And since the word “edges” is behind the retrieved term of “circuit board”, the word “edges” is taken as a minor element. Thereafter, the preceding noun and the pseudo position to be truncated are to be erased. The method of the present invention then continues to read the next word, which is [a] as expressed by “a circuit board provided with edges extending in [a] longitudinal direction of said circuit board;”. The logic that retrieves the term of “longitudinal direction” is the same as the previous explanation. That is, next, the word [longitudinal] is read as expressed as “a circuit board provided with edges extending in a [longitudinal] direction of said circuit board;”. Since [longitudinal] does not belong to any group of part of speech, the method of the present invention continues to read the next word, which is [direction] as expressed as “a circuit board provided with edges extending in a longitudinal [direction] of said circuit board;”. Since [direction] does not belong to any group of part of speech, the method of the present invention continues to read the next word, which is [of] as expressed as “a circuit board provided with edges extending in a longitudinal direction [of] said circuit board;”. Since [of] belongs to the group of prepositions, the method then proceeds to perform the processing procedures illustrated in the row numbered “11” to the row numbered “13”. These four processing procedure share a common feature, i.e. to take the position of the preposition to be a pseudo position to be truncated. The method of the present invention then continues to read the next word to decide which processing procedure to choose. Next, the word “said” is obtained as expressed as “a circuit board provided with edges extending in a longitudinal direction of [said] circuit board;”. Since [said] belongs to the group of preceding noun, the row numbered “11” is selected, i.e. the position of the preposition [of] is determined as a truncate position, and then the words from [of] backward to [a] are retrieved, which are words of “longitudinal direction”. And the term “longitudinal direction” is within the definition of an element, and is behind the main element “A circuit board”, so the term “longitudinal direction” is determined as a minor element. The method then continues to read the next word of “said”, and the term of “circuit board” is retrieved. Since the term “circuit board” has been retrieved, and the term a preceding noun which also indicates the term has appeared before, the term “circuit board” is deleted from the retrieval. It is noted that the symbol [;] in the end of text belongs to the group of ending words, the method ceases retrieving and proceeds to disassemble and analyze the next main element in the next paragraph.

The dependent-claim-element-analyzing step (S16) as shown in FIG. 1 disassembles the dependent claim, where the dependent claim is determined by the claim dependency determining step. The step S16 disassembles a definition portion after a comma in the dependent claim, thereby obtaining a main element of the dependent claim and a minor element of the dependent claim. In this step, comma is used to disassemble sentences, thereby obtaining main elements and minor elements. The way in prior art where it builds specific database tables is relatively complicated and less efficient. Via using comma as a tool of disassembly, the present invention does not need to build database tables of terms such as “wherein”, “furthermore”, and “further”, thereby enhancing the efficiency of disassembling and analyzing. The logic of obtaining the main elements and minor elements in a dependent claim is the same as that of obtaining the main elements and minor elements in an independent claim, so the logic of obtaining the main elements and minor elements in a dependent claim is not further explained herein.

In the present invention, a preamble is furthered disassembled to obtain a main preamble and a minor preamble. The main preamble and the minor preamble are retrieved with the same logic procedures of obtaining the main elements and minor elements in a dependent claim. The main preamble and the minor preamble are determined according to the positions thereof. A preamble appears in the most previous position is taken as the main preamble, and a preamble appears behind the main preamble is taken as a minor preamble

In one embodiment of the present invention, the patent claims disassembling and analyzing method further determine the mutual relationship between the main element and the minor element for both of an independent claim and a dependent claim. The terms of mutual relationships between main elements and minor elements are determined by participle terms which are positioned between the main elements and the minor elements. Taking the text “a circuit board provided with edges extending in a longitudinal direction of said circuit board;” as an example, “a circuit board” is a main element and “edges” is a minor element, wherein the participle “provided” positioned therebetween is determined as the mutual relationship between a main element and a minor element. The mutual relationship comprises a connecting relationship and/or a superior-subordinate relationship and/or a positional relationship. The connecting relationship comprises “connect”, “be connected with each other”, etc. The superior-subordinate relationship comprises “has/have”, “comprising”, etc. The positional relationship comprises “be disposed”, “is configured”, etc.

As shown in FIG. 2, the main preamble and the minor preamble are retrieved by means of the detection of colons and the detection of commas. In this step, database table is not required, thereby saving computation time and manual examination time.

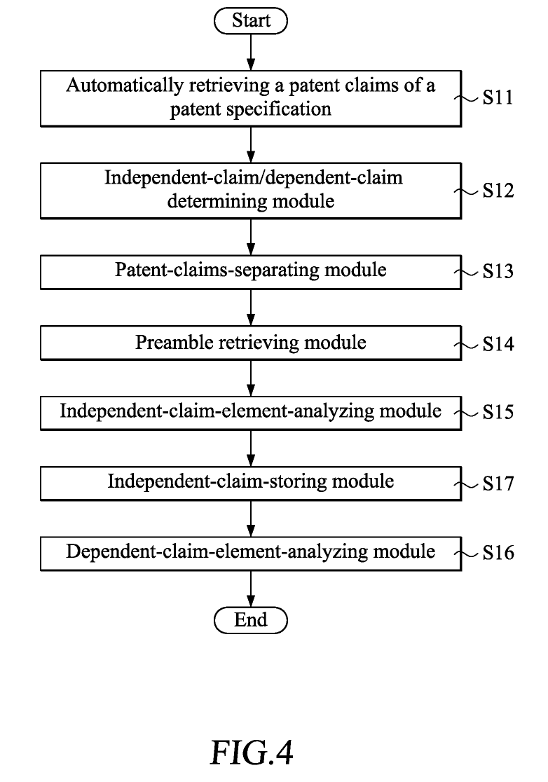

As shown in FIG. 4, the patent claims disassembling and analyzing method further comprises an independent-claim storing step (S17) which stores, in an independent-claim-database table, a preamble of an independent claim, all of the main elements and the minor elements belonging to the independent claim, and the mutual relationships between main elements and minor elements.

Moreover, the patent claims disassembling and analyzing method further comprises a dependent-claim storing step (S18) which stores, in a dependent-claim-database table, a preamble of a dependent claim, all of the main elements and minor elements of the dependent claim, all of the main elements and minor elements of the independent claim on which the dependent claim depends, and the mutual relationships between main elements and minor elements.

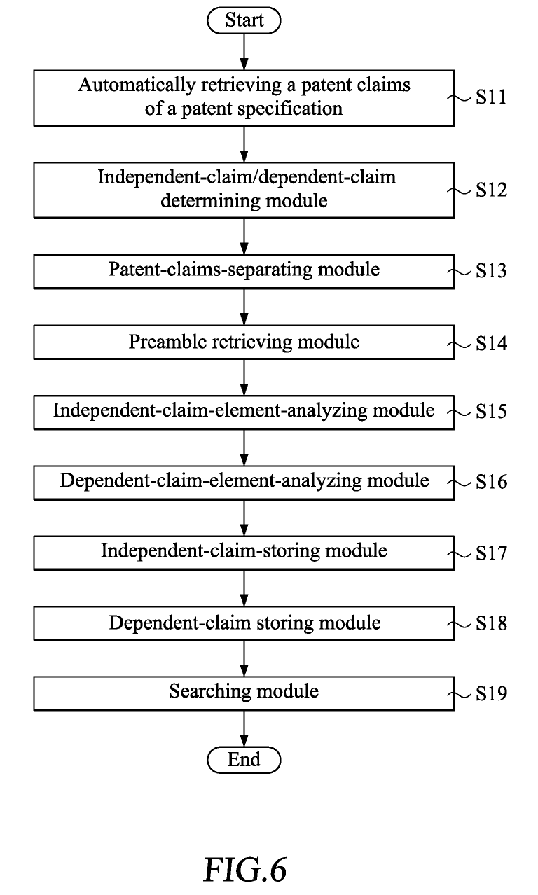

As shown in FIG. 6, the patent claims disassembling and analyzing method further comprises a searching step (S19) which searches the independent-claim-database table and the dependent-claim-database table so as to obtain data in connection to a patent specification to which the independent-claim-database table and the dependent-claim-database table belong.

The patent claims disassembling and analyzing method of the present invention is inventive and efficient since it utilizes part of speech to disassemble and analyze patent claims to obtain main elements and minor elements, utilizes storage space in a more efficient way having computation time more speedy over the prior arts. Furthermore, the present invention does not further separate the definition of the text after the colon. Instead, the patent claims disassembling and analyzing method of the present invention directly disassembles the text after the colon and thus obtains each main element and the minor element corresponding to the main elements.

The above description is only an explanation of the preferred embodiment of the present invention. A person with ordinary skill in the art can make various modifications to the present invention based on the scope of the claims and the above description. However, those modifications shall fall within the scope of the present invention.

1. A patent claims disassembling and analyzing device which automatically retrieves a patent claims from a patent specification, the device comprising:
an independent-claim/dependent-claim determining module which determines whether one claim of the patent claims is an independent claim or a dependent claim;
a patent-claims-separating module which separates the patent claims into individual claims according to a symbol combination of a numbering and a punctuation mark in the patent claims;
a preamble retrieving module which retrieves a preamble from each individual claim separated from the patent claims by the patent-claims-separating module;
an independent-claim-element-analyzing module which disassembles the independent claim determined by the claim dependency determining module by disassembling a definition in a portion after a colon in the independent claim, thereby obtaining a main element of the independent claim and a minor element of the independent claim; and
a dependent-claim-element-analyzing module which disassembles the dependent claim determined by the claim dependency determining module by disassembling a definition portion after a comma in the dependent claim, thereby obtaining a main element of the dependent claim and a minor element of the dependent claim,
wherein in the independent-claim-element-analyzing module and the dependent-claim-element-analyzing module, each individual claim in the patent claims is analyzed according to a predefined logic based on English grammar rules for sentence structure in a manner that main elements and minor elements of an independent claim and main elements and minor elements of a dependent claim are obtained by disassembling each individual claim in accordance with a location of a noun-preceding word in each individual claim, a part of speech of a word behind the noun-preceding word, and a word-arrangement sequence of the words with specific parts of speech located behind the noun-preceding word.

2. The patent claims disassembling and analyzing device of claim 1, wherein the preamble retrieving module includes retrieving a main preamble and a minor preamble.

3. The patent claims disassembling and analyzing device of claim 1, wherein the independent-claim-element-analyzing module and/or the dependent-claim-element-analyzing module further determine the mutual relationship between the main element of an independent claim and the minor element of a dependent claim, and determine the mutual relationship between the main element of a dependent claim and the minor element of a dependent claim.

4. The patent claims disassembling and analyzing device of claim 2, wherein the main preamble and the minor preamble are retrieved by means of the detection of colons and the detection of commas.

5. The patent claims disassembling and analyzing device of claim 1, wherein the patent claims disassembling and analyzing device further comprises an independent-claim storing module which stores, in an independent-claim-database table, a preamble of an independent claim and all of the main elements and the minor elements belonging to the independent claim.

6. The patent claims disassembling and analyzing device of claim 5, wherein the patent claims disassembling and analyzing device further comprises a dependent-claim storing module which stores, in a dependent-claim-database table, a preamble of a dependent claim, all of the main elements and minor elements of the dependent claim, and all of the main elements and minor elements of the independent claim on which the dependent claim depends.

7. The patent claims disassembling and analyzing device of claim 6, wherein the patent claims disassembling and analyzing device further comprises a searching module which searches the independent-claim-database table and the dependent-claim-database table so as to obtain data relating to a patent specification to which the independent-claim-database table and the dependent-claim-database table belong.

8. The patent claims disassembling and analyzing device of claim 3, wherein the mutual relationship includes a connecting relationship and/or a superior-subordinate relationship and/or a positional relationship.

9. The patent claims disassembling and analyzing device of claim 1, wherein the independent-claim-element-analyzing module and/or the dependent-claim-element-analyzing module perform an operation which directly disassembles the definition part located behind the colon to obtain all the main elements and the minor elements corresponding to each main element rather than performing an operation which further divides the definition portion located behind the colon.
